(19) United States
(12) Patent Application Publication
(10) Pub. No.: US 2026/0243866 A1
(43) Pub. Date: Aug. 20, 2026

(54) NON-UNIFORM QUANTIZATION OF RADAR SIGNAL DATA

(71) Applicant: The Board of Regents of the University of Oklahoma, Norman, OK (US)

(72) Inventors: Ayano Ueki, Norman, OK (US); Robert D. Palmer, Norman, OK (US); Boonleng Cheong, Norman, OK (US); Sebastian Torres, Norman, OK (US)

(21) Appl. No.: 19/544,071

(22) Filed: Feb. 19, 2026

Related U.S. Application Data
(60) Provisional application No. 63/760,716, filed on Feb. 20, 2025.

(51) Int. Cl. G01S 7/28; G01S 13/89; G01S 13/95; H01Q 21/00

(52) U.S. Cl. CPC G01S 7/2813; G01S 13/89; G01S 13/95; H01Q 21/00

(57) ABSTRACT

Non-uniform quantization of I/Q radar data reduces the storage burden for large amounts of data generated by radars. This is acute challenge for digital phased array radars. Non-uniform quantization reduces quantization errors in low-SNR signals, increasing dynamic range for low bit-depths (e.g., 5 to 8) relative to uniform quantization. Enabling the use of fewer bits to represent data results in more efficient storage, such as requiring only 31% to 50% of the original storage space. Examples quantize radar signals using non-uniform quantization intervals at a selected bit depth. In some examples, quantization intervals follow an inverse μ-law function (e.g., with μ=255). This trades lower resolution at high amplitudes in favor of higher resolution at lower amplitudes, thereby reducing quantization noise as a percentage of signal strength. In some examples, the bit-depth may be selected based on a specific radar variable of interest (e.g., SNR, reflectivity, Doppler velocity, polarimetric variables).

### CROSS-REFERENCE TO RELATED APPLICATIONS

This application claims priority to U.S. Provisional Patent Application No. 63/760,716, filed on Feb. 20, 2025, the entire disclosure of which is incorporated herein by reference.

### GOVERNMENT RIGHTS

This invention was made with government support under Cooperative Agreement No. NA21OAR4320204 awarded by National Oceanic and Atmospheric Administration (NOAA). The government has certain rights in the invention.

### BACKGROUND

Fully digital phased array radars (PARs) offer several advantages, including rapid and effective weather observations due to beam agility, imaging capabilities, adaptive beamforming, and adaptive scanning. However, depending on the scan strategies employed, the system must transfer, process, and store element-level in-phase and quadrature phase (I/Q) data in real-time, resulting in the generation of massive amounts of data.

For example, the Horus radar system is a fully digital S-band PAR operating at 2.7 gigahertz (GHz) to 3.1 GHz, with up to 1,600 independent radiating elements and can produce element-level dual polarization I/Q data for each element. Using a standard weather radar sampling rate of 20 million samples per second (MS/s) and (uniform) quantization at 16 bits (i.e., a bit depth of 16, two bytes) per sample, 256 gigabytes per second (GB/s) of data can produced.

### BRIEF DESCRIPTION OF THE DRAWINGS

The disclosed examples are described below with reference to the accompanying drawing figures listed below, wherein:

FIG. 1 illustrates an exemplary architecture that advantageously provides for non-uniform quantization of radar signal data;

FIG. 2 illustrates an exemplary radar receiver that may be employed in examples of the architecture of FIG. 1;

FIG. 3 illustrates an exemplary non-uniform signal quantizer that may be employed in examples of the architecture of FIG. 1;

FIG. 4 illustrates a comparison between uniform and non-uniform quantization intervals;

FIGS. 5A and 5B illustrate a comparison between performing uniform quantization and non-uniform quantization on a signal;

FIG. 6A illustrates exemplary errors in radar variables for a uniform quantization scenario;

FIG. 6B illustrates exemplary errors in radar variables for a non-uniform quantization scenario, as may occur when using examples of the architecture of FIG. 1;

FIGS. 7A and 7B illustrate a comparison between exemplary dynamic ranges when performing uniform quantization and non-uniform quantization on a signal;

FIG. 8 illustrates exemplary comparisons of in-phase and quadrature phase (I/Q) radar data for various quantization scenarios;

FIG. 9 illustrates further detail for generation of an output data product, as may occur when using examples of the architecture of FIG. 1;

FIGS. 10 and 11 illustrate flowcharts of exemplary operations associated with the architecture of FIG. 1; and

FIG. 12 illustrates a block diagram of a computing device suitable for implementing various aspects of the disclosure.

The various examples will be described in detail with reference to the accompanying drawings. Wherever preferable, the same reference numbers will be used throughout the drawings to refer to the same or like parts. References made throughout this disclosure, relating to specific examples, are provided for illustrative purposes, and are not meant to limit all implementations or to be interpreted as excluding the existence of additional implementations that also incorporate the recited features.

### DETAILED DESCRIPTION

Non-uniform quantization of in-phase and quadrature phase (I/Q) radar data reduces the storage burden for the vast amounts of data generated by digital phased array radars. Non-uniform quantization reduces quantization errors in low signal to noise ratio (SNR) signals, increasing dynamic range relative to uniform quantization. Enabling the use of fewer bits to represent the data results in more efficient transfer and storage of data for later processing, such as requiring only 31% to 50% of the storage space. Data may then be subjected to digital beamforming at a later time for generating output data products, or could possibly be previously beamformed data. Examples quantize a radar signal using non-uniform quantization intervals at a selected bit depth. In some examples, the quantization intervals follow an inverse μ-law function (e.g., with μ=255).

This trades lower resolution at high amplitudes in favor of higher resolution at lower amplitudes, thereby reducing quantization noise as a percentage of signal strength. The bit depth may typically be chosen based on acceptable error levels for radar variable of interest (e.g., SNR, reflectivity, Doppler velocity, polarimetric variable). In this manner, aspects of the disclosure improve the operation of radars by significantly reducing the burden of transferring, processing, and storing data, such as I/Q radar data.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. For example, the various apparatus and devices of the various embodiments described herein may be constructed using various off-the shelf components, such as PCBs, and other mechanical and electrical components which perform the same function as the particular components described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entireties to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that a thing possesses or occurs in an amount, duration, degree or other measure or parameter value that is 90% to 99% of which the thing is being compared to.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

As used herein any reference to “we” as a pronoun may include laboratory personnel or other contributors who assisted in the laboratory procedures and data collection and is not intended to represent an inventorship role by said laboratory personnel or other contributors in any subject matter disclosed herein.

Where used herein the term “integrated circuit” is also intended to refer to a device known as a semiconductor chip, a microchip, a computer chip, and a microprocessor chip.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The term “exemplary” is intended to mean “an example of”.

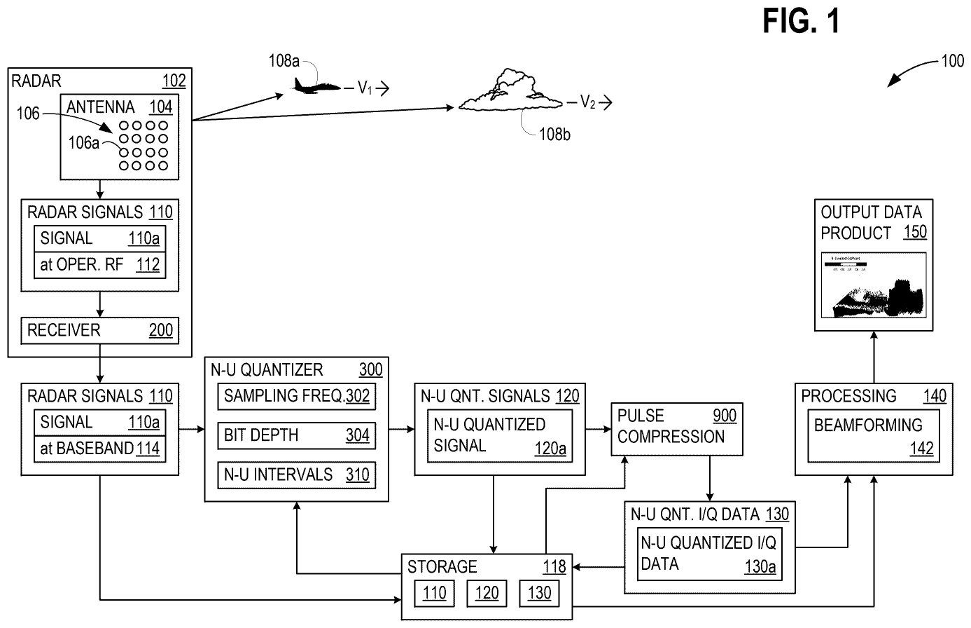

Returning now to the description of several embodiments of the disclosure, reference is now made to the figures, FIG. 1 illustrates an exemplary architecture 100 that advantageously provides for non-uniform quantization of radar signal data. Architecture 100 has a weather surveillance radar 102 operating as a phased array radar (PAR), although the teachings herein apply to dish-based radars and radars used for other functions, such as air traffic control. Weather surveillance radar 102 has a radar antenna 104, shown as a phased array with elements 106. In some examples, the count of elements 106 is 1,600. For applications using conventional dish-based radars, there is only a single phase center element.

Reflections are received from a target 108a, illustrated as an aircraft, and a target 108b, illustrated as a storm (using a graphic of a cloud), possibly with wind and precipitation. Target 108a has a velocity V₁, and target 108b has a velocity V₂, both of which provide Doppler shifts for reflected radar signals.

When radar antenna 104 has a single phase center (i.e., weather surveillance radar 102 is a real-beam radar, also known as a dish-based radar) radar antenna 104 outputs a radar signal 110a. However, when radar antenna 104 is a phased array with elements 106 (i.e., weather surveillance radar 102 is a PAR), radar antenna 104 outputs a plurality of radar signals 110, of which radar signal 110a, described herein, is just one. In such examples, each radar signal of plurality of radar signals 110 corresponds to an element 106 of the phased array. The remaining description follows radar signal 110a as it progresses into a non-uniform quantized radar signal 120a, and then into non-uniform quantized I/Q radar data 130a. It should be understood that the description for a single radar signal also applies to each signal of plurality of radar signals 110 as they progress into a plurality of non-uniform quantized radar signals 120, and then into a plurality of non-uniform quantized I/Q radar data 130. It should also be understood that each of plurality of non-uniform quantized I/Q radar data 130 should be considered to be compressed, due to the reduced bit depth.

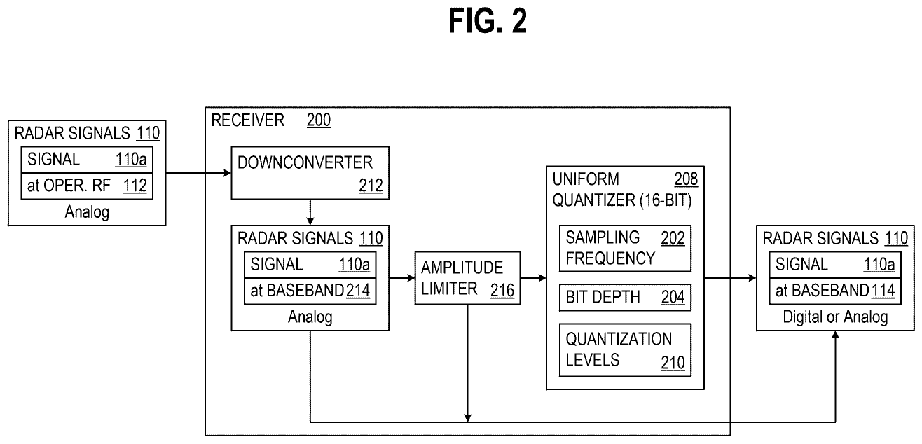

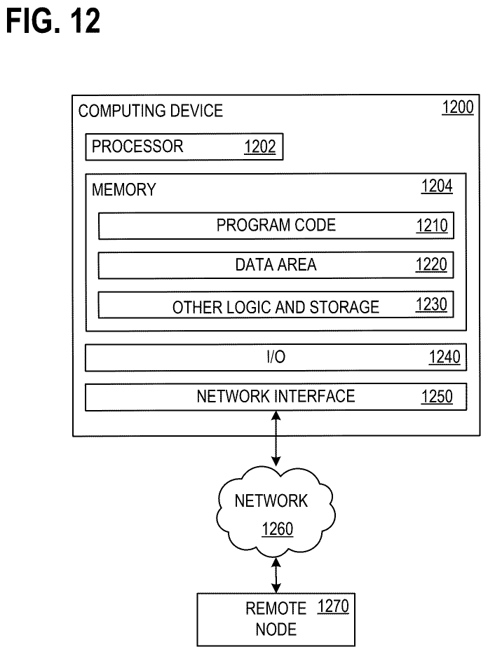

Radar signal 110a is at an operational radio frequency (RF) 112. Some examples use an RF between 2.5 gigahertz (GHz) and 3.5 GHz, such as 2.7-3.1 GHz, although other frequencies may also be used. A radar receiver 200 downconverts radar signal 110a to a baseband frequency 114, and (in some examples) quantizes radar signal 110a at 16-bits (i.e., with a bit depth of 16). Radar receiver 200 is shown in further detail in FIG. 2. In some examples, radar signal 110a is sent directly to a non-uniform quantizer 300. In some examples, radar signal 110a is stored in a storage device 118, and non-uniform quantizer 300 is able to read radar signal 110a from storage device 118 at a later time. Storage device 118 is a non-transitory computer readable medium, such as a memory 1204 of a computing device 1200, which is shown in FIG. 12.

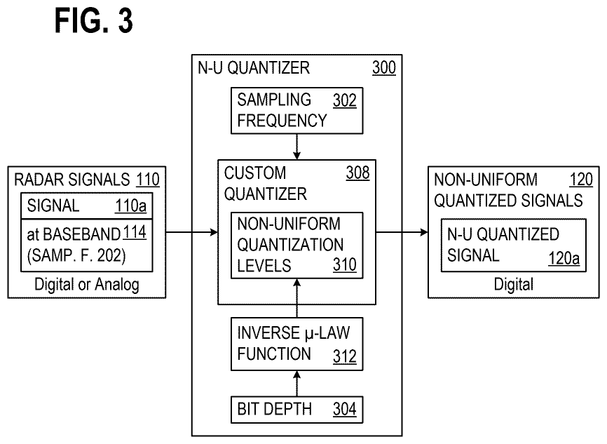

Non-uniform quantizer 300 quantizes radar signal 110a at a sampling frequency 302 and a bit depth 304, using quantization intervals 310 that are not non-uniform. In some examples, sampling frequency 302 is based on baseband frequency 114. In some examples, if radar signal 110a is already quantized (e.g., at 16-bits), sampling frequency 302 is selected to be the same as the sampling frequency at which radar signal 110a was previously quantized. In some examples, sampling frequency 302 is between 15 megasamples per second (MS/s) and 25 MS/s, inclusive, such as 20 MS/s. In some examples, sampling frequency 302 is below a Nyquist rate of baseband frequency 114. This is feasible because, since operational RF 112 is known, aliasing may be filtered out, later. In some examples, bit depth 304 is between 5 and 8, inclusive, such as 6 or 7. Non-uniform quantizer 300 is shown in further detail in FIG. 3.

Non-uniform quantizer 300 outputs non-uniform quantized radar signal 120a, which may be stored in storage device 118 for further processing at a later time, or sent directly to pulse compression filter 900. In some examples, non-uniform quantized radar signal 120a replaces radar signal 110a in storage device 118, freeing up space, since non-uniform quantized radar signal 120a has a lower bit depth than radar signal 110a, such as 5 to 8 versus 16. This means that non-uniform quantized radar signal 120a requires between 31% and 50% of the storage space of radar signal 110a. Pulse compression filter 900 helps to mitigate quantization noise. In some examples, pulse compression filter 900 precedes non-uniform quantizer 300 in the processing order. The length of pulse compression filter 900 depends on sampling frequency 202, which is dependent on the required bandwidth. For example, sampling frequency 202 is typically chosen to be double the required bandwidth. For a pulse length of 100 microseconds and a bandwidth of 2 MHz (sampling frequency of 4 MHz) the compression filter length (i.e., length pf pulse compression filter 900) is 400 samples. If the bandwidth is increased to 5 MHz, the compression filter length would then be 1,000 samples.

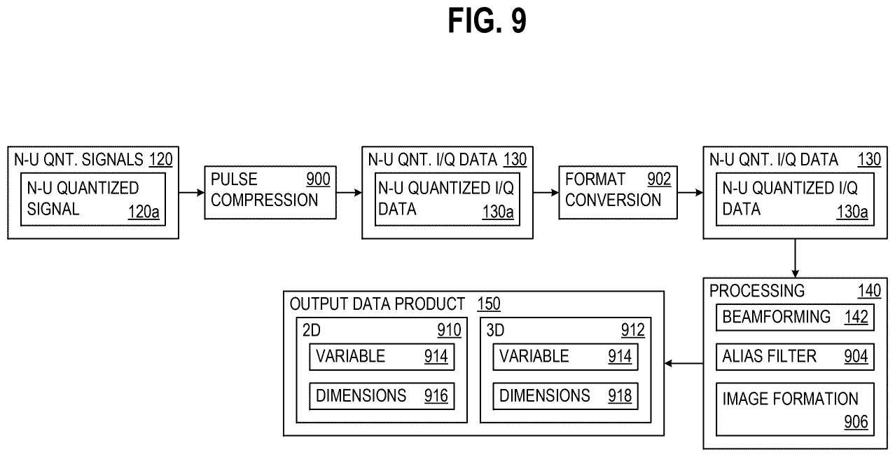

Pulse compression filter 900 converts non-uniform quantized radar signal 120a into non-uniform quantized I/Q radar data 130a, which is sent directly to processing 140 for generation of an output data product 150 and/or may be stored in storage device 118 for consumption by processing 140 at a later time. Some examples of pulse compression filter 900 use a beamformer 142. Pulse compression filter 900, processing 140, and output data product 150 are shown in further detail in FIG. 9.

FIG. 2 illustrates further detail for radar receiver 200. Radar receiver 200 receives radar signal 110a (or plurality of radar signals 110 for PAR examples) as an analog signal at operational RF 112 and downconverts it with a downconverter 212 to a baseband frequency 214. At this point, radar signal 110a has I/Q components. In some examples, radar receiver 200 provides radar signal 110a directly to non-uniform quantizer 300 as an analog signal. In such examples, baseband frequency 214 is the same as baseband frequency 114. In some examples, however, radar receiver 200 outputs radar signal 110a as a quantized digital signal, which is also suitable for storage in storage device 118.

Some examples clip radar signal 110a (i.e., limit amplitude) based on an expected amplitude range of typical signal values, using an amplitude limiter 216. In some scenarios, a radar signal stays within some amplitude range (i.e., ±some maximum absolute value) for 99% of the time. Any signals exceeding this amplitude range may be considered overload noise. In such scenarios, amplitude limiter 216 may clip radar signal 110a (i.e., the I/Q data of radar signal 110a) by limiting the extreme values to remain within the 99% amplitude range. This is done to limit the range of values for quantization.

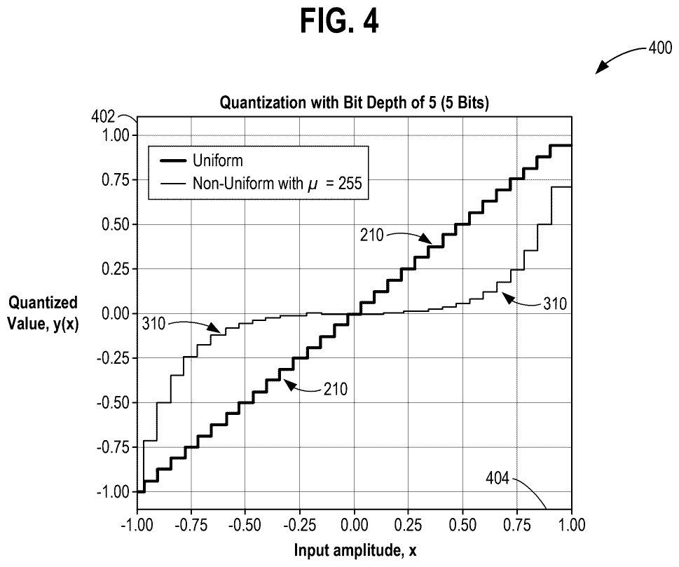

In examples that output a digital radar signal 110a, a uniform quantizer 208 performs sampling (quantization) with a sampling frequency 202, at a bit depth 204, using uniform quantization intervals 210. Exemplary quantization is shown in FIG. 4. Sampling frequency 202 may be the same as sampling frequency 302 (or may be higher). In some examples, bit depth 204 is 16, which provides over 65,000 levels for uniform quantization intervals 210.

FIG. 3 illustrates further detail for non-uniform quantizer 300. Non-uniform quantizer 300 receives radar signal 110a (or plurality of radar signals 110 for PAR examples) as an analog signal or an already-quantized digital signal at baseband frequency 114. Sampling frequency 302, and (non-uniform) quantization intervals 310 are selected based on at least characteristics of the data that are needed for output data product 150, as described below. In some examples, if radar signal 110a is already quantized (e.g., at 16-bits), sampling frequency 302 is selected to be the same as sampling frequency 202 at which radar signal 110a was previously quantized by uniform quantizer 208.

Quantization intervals 310 are determined by bit depth 304 and a quantization profile function that is shown as an inverse μ-law function 312. Other quantization profiles may be used, in some examples. Bit depth 304 is also selected based on at least characteristics of the data that are needed for output data product 150, as described below, and may range from 5 to 8, inclusive, such as 6 or 7. A custom quantizer 308 transforms radar signal 110a into non-uniform quantized radar signal 120a (or transforms plurality of radar signals 110 into plurality of non-uniform quantized radar signals 120, if applicable).

Inverse μ-law function 312, y(x), is given as:

$$f ( x ) = V \frac{ln ( 1 + \frac{μ \vert x \vert}{V} )}{ln ( 1 + μ )} \qquad Eq . ( 1 )$$

$$y ( x ) = {f}^{- 1} ( x ) = sgn ( x ) \frac{V \vert {e}^{x \frac{l n ( 1 + μ )}{V}} - 1 \vert}{μ} \qquad Eq . ( 2 )$$

where x is radar signal 110a, V is an amplitude limit of radar signal 110a, such that |x|≤V.

The value of controls the aggressiveness of the quantization, with small values of more closely approximating uniform quantization, and larger values of expanding the difference in resolution for lower amplitude signal values versus higher-amplitude signal values. In some examples, ranges between 200 and 300, inclusive, such as =255.

FIG. 4 illustrates a comparison between uniform quantization intervals and non-uniform quantization intervals at a bit depth of 6, using inverse μ-law function 312 (Eq. (1)) with μ=255. A plot 400 shows both quantization intervals 310, which are clearly non-uniform, and uniform quantization intervals 210 plotted using a quantized value axis 402 versus an input amplitude axis 404. Plot 400 shows that the input value, x, is assigned to the nearest quantization level. Uniform quantization divides the dynamic range of x into equal quantization levels, whereas non-uniform quantization divides the dynamic range into variable intervals, allowing for more flexible representation of signals.

In the example of FIG. 4, non-uniform quantization adjusts the sizes of quantization intervals 310 according to the signal's amplitude distribution, providing enhanced accuracy for low-amplitude signals. This approach is particularly beneficial in weather radar applications, where capturing signal variations from weak returns is important. By allocating more quantization levels to lower amplitude signals, non-uniform quantization improves the representation of weak signals, making it an effective data reduction approach for weather radar.

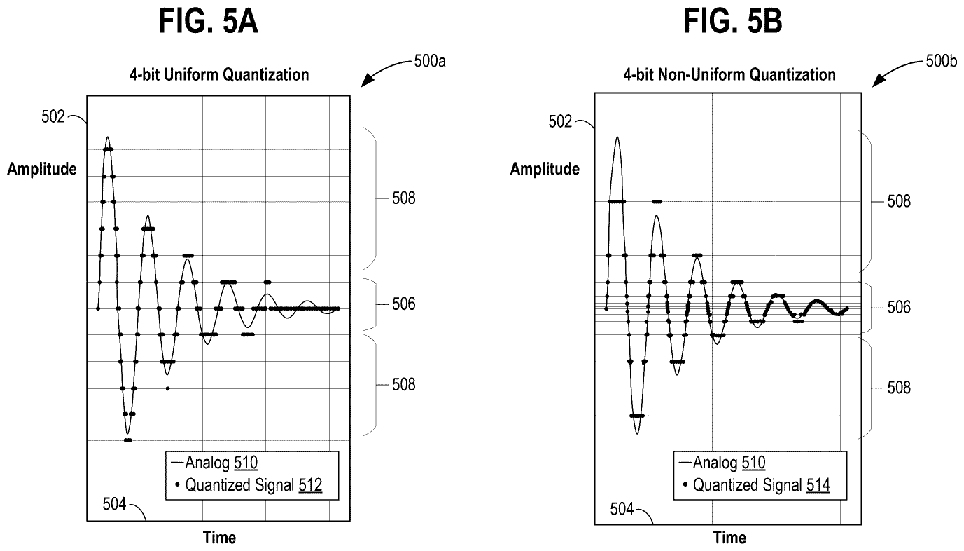

FIGS. 5A and 5B illustrate a comparison between performing uniform quantization and non-uniform quantization on a signal. FIG. 5A shows a plot 500a of quantizing an analog signal 510 into a quantized signal 512 with 4-bit uniform quantization (i.e., a bit depth of 4), plotting the values using an amplitude axis 502 and a time axis 504. FIG. 5B shows a plot 500b of quantizing analog signal 510 into a quantized signal 514 with 4-bit non-uniform quantization, plotting the values using amplitude axis 502 and time axis 504. The quantization of FIG. 5B uses inverse μ-law function 312 (Eq. (1)) with μ=255. FIG. 5B thus shows quantization intervals 310 if bit depth 304 were set to 4.

As can be seen in a comparison of plot 500a with plot 500b, with non-uniform quantization, low amplitude signals 506 are represented well with higher resolution, whereas high amplitude signals 508 have lower resolution. The selection of the quantization levels directly impacts quantization error by governing how the sampling range is divided. With higher resolution for low amplitude signals 506, the ratio of the quantization noise to the signal strength is reduced. Quantization noise is defined as the difference between the original input x and the output quantized value.

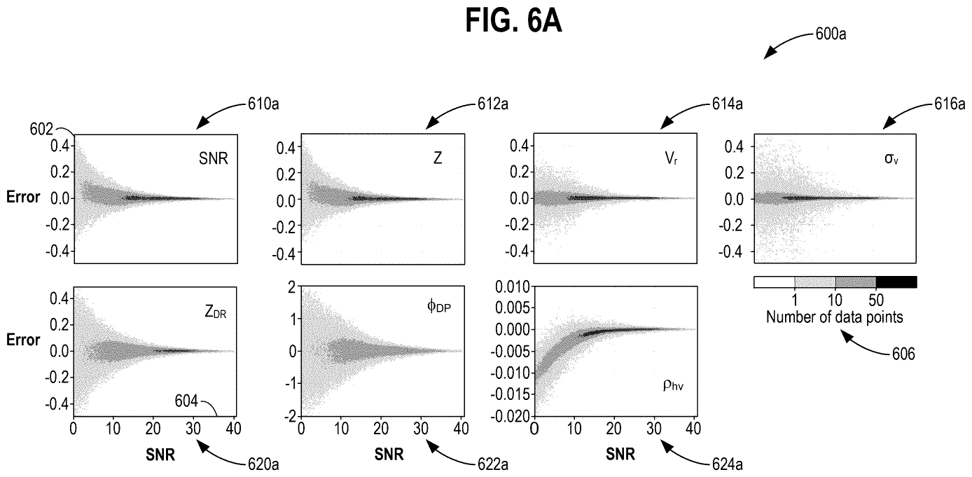

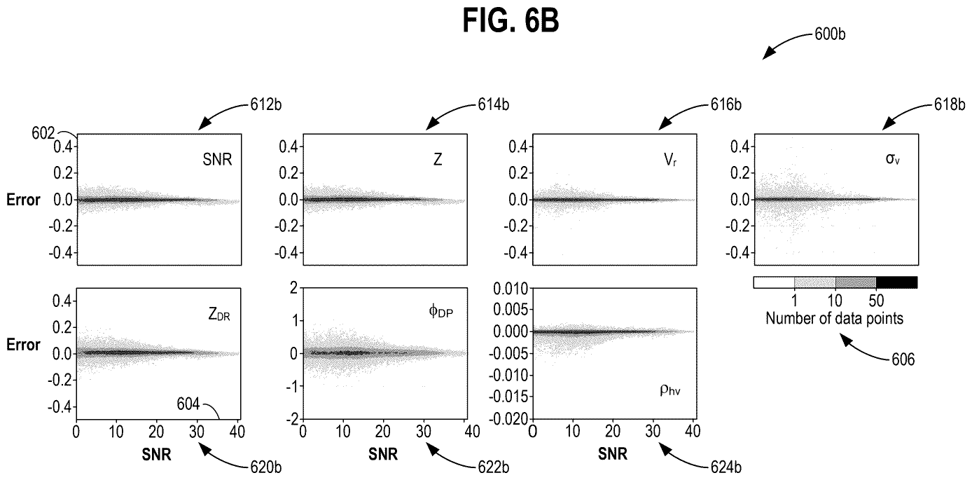

A comparison of noise for uniform versus non-uniform quantization, with a bit depth of 8, is apparent by contrasting FIG. 6A with FIG. B. However, it is instructive to provide background information on signal processing techniques used with weather radars. The typical first step in a polarimetric weather radar signal processing chain is the estimation of the auto- and cross-correlation functions:

$${R}_{h} ( τ ) = E [ {V}_{h} ( t ) {V}_{h}^{*} ( t - τ ) ] \qquad Eq . ( 3 )$$

$${R}_{v} ( τ ) = E [ {V}_{v} ( t ) {V}_{v}^{*} ( t - τ ) ] \qquad Eq . ( 4 )$$

$${R}_{h v} ( τ ) = E [ {V}_{v} ( t ) {V}_{h}^{*} ( t - τ ) ] \qquad Eq . ( 5 )$$

where Rₕ and Rᵥ are the auto-correlation functions for horizontal and vertical polarizations, respectively; Rᵥₕ is the cross-correlation function; Vₕ and Vᵥ are the baseband I/Q signals of radar signal 110a for horizontal and vertical polarizations, respectively, and * denotes complex conjugation.

Rₕ, Rᵥ, and Rᵥₕ are fundamental to characterizing the statistical properties of the received signals. These values enable calculating signal values S and 9, for the horizontal and vertical polarizations:

$${\hat{S}}_{h} = {\hat{R}}_{h} ( 0 ) - {\hat{N}}_{h} \qquad Eq . ( 6 )$$

$${\hat{S}}_{v} = {\hat{R}}_{v} ( 0 ) - {\hat{N}}_{v} \qquad Eq . ( 7 )$$

where \hat{N}ₕ and \hat{N}ᵥ are the noise levels for horizontal and vertical polarizations, respectively. This enables calculation of; Rᵥₕ is the cross-correlation function; Vₕ and Vᵥ are the baseband I/Q signals of radar signal 110a for horizontal and vertical polarizations, respectively, and * denotes complex conjugation.

Rₕ, Rᵥ, and Rᵥₕ are fundamental to characterizing the statistical properties of the received signals. These values enable calculating several weather radar variables 914 that may be used to both assess the impact of quantization on measurement accuracy, as well as be plotted in output data product 150. These weather radar variables 914 include:

$$\hat{Z} = 10 {log}_{10} ( {\hat{S}}_{h} {r}^{2} ) + C \qquad Eq . ( 8 )$$

$${\hat{v}}_{r} = - \frac{λ}{4 π {T}_{s}} ∠ {\hat{R}}_{h} ( {T}_{s} ) \qquad Eq . ( 9 )$$

$${\hat{σ}}_{v} = {\frac{λ}{2 π {T}_{s} \sqrt{2}} [ ln ( \frac{{\hat{S}}_{h}}{\vert {\hat{R}}_{h} ( {T}_{s} ) \vert} ) ]}^{1 / 2} \qquad Eq . ( 10 )$$

$${\hat{Z}}_{D R} = 10 {log}_{10} \frac{{\hat{S}}_{h}}{{\hat{S}}_{v}} \qquad Eq . ( 11 )$$

$${\hat{ϕ}}_{D P} = ∠ {\hat{R}}_{h v} ( 0 ) \qquad Eq . ( 12 )$$

$${\hat{ρ}}_{h v} = \frac{\vert {\hat{R}}_{h v} ( 0 ) \vert}{\sqrt{{\hat{S}}_{h} {\hat{S}}_{v}}} \qquad Eq . ( 13 )$$

where \hat{Z} is the reflectivity factor, r² is the range-correlation term, C is the calibration factor, \hat{v}ᵣ is the Doppler velocity, λ is the transmitter wavelength, Tₛ is the pulse repetition time (PRT), and \hat{σ}ᵥ is the spectrum width. Polarimetric variables \hat{Z}_{DR}, \hat{φ}_{DP}, and \hat{ρ}ₕᵥ, are then estimated. \hat{Z}_{DR} is the spectrum reflectivity, \hat{φ}P_{DP} is the specific differential phase, and \hat{ρ}ₕᵥ, is the correlation coefficient.

FIG. 6A illustrates exemplary errors in radar variables for uniform quantization scenario with a bit depth of 8. A set of plots 600a includes a plot 610a for SNR, a plot 612a for \hat{Z}, a plot 614a for \hat{v}ᵣ, a plot 616a for \hat{σ}ᵥ, a plot 620a for variables \hat{Z}_{DR}, a plot 622a for \hat{φ}_{DP}, and a plot 624a for \hat{ρ}ₕᵥ. The errors in the estimated radar variables are calculated as the difference between the radar variables obtained with 8-bit quantization and those from 16-bit reference data that is used as ground-truth. Each plot charts the errors on an error amplitude axis 602 versus a signal amplitude axis 604, represented as SNR. A legend 606 indicates a count of points at a particular location in each plot, using a grayscale intensity as a histogram variable with a darker color indicating a higher concentration of points. As can be seen in set of plots 600a, lower signal values produce higher errors for all weather radar variables 914.

FIG. 6B illustrates exemplary errors in radar variables for non-uniform quantization scenario with a bit depth of 8, using inverse μ-law function 312 (Eq. (1)) with μ=255. A set of plots 600b includes a plot 610b for SNR, a plot 612b for \hat{Z}, a plot 614b for pr, a plot 616b for \hat{σ}ᵥ, a plot 620b for variables \hat{Z}_{DR}, a plot 622b for \hat{φ}_{DP}, and a plot 624b for \hat{ρ}ₕᵥ. The errors in the estimated radar variables are calculated and plotted the same as for FIG. 6A. The reduction in error for lower signal values is noticeable.

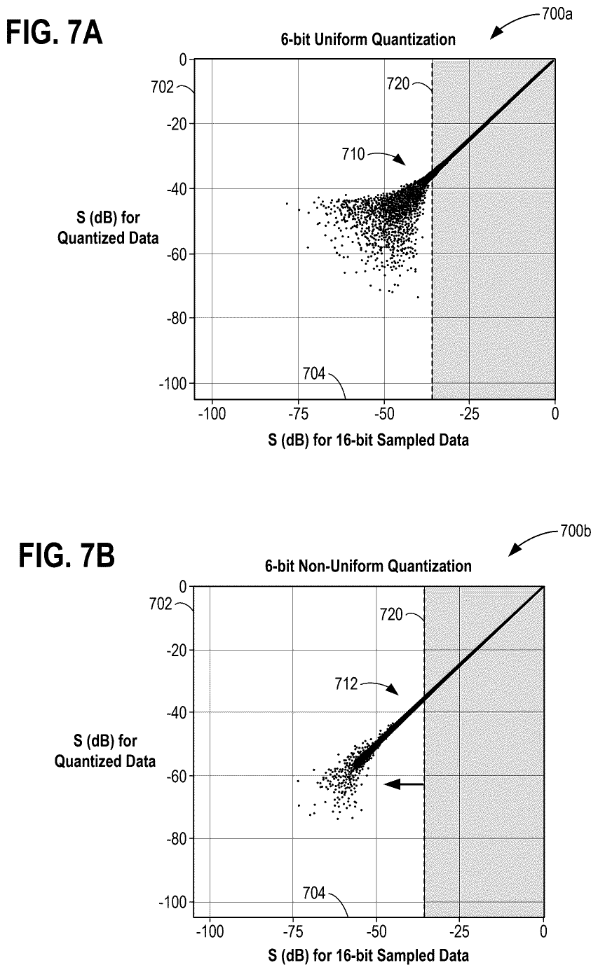

This reduction in error for lower signal values significantly expands the dynamic range, as shown in FIGS. 7A and 7B, using a definition of dynamic range based on acceptable error of weather radar variables 914. Dynamic range may be visualized by plotting the normalized signal value (S) estimates for the quantization against 16-bit reference S estimates. FIG. 7A shows results for uniform quantization at 6-bits as a scatter plot 700a, with data points 710 plotted using a signal value (in decibels, dB) axis 702 for the 6-bit quantization versus a signal value axis 704 for the 16-bit quantized reference values. If the 6-bit quantization did not introduce any errors, estimates had no error, data points 710 would manifest as a single straight one-to-one line. Instead, data points 710 fans out, demonstrating significant errors at low signal values.

A theoretical dynamic range limit is indicated by a vertical line 720, calculated as −6 times the number of bits used in the quantization. This is −36 dB for 6-bits quantization. As can be seen, data points 710 begins fanning out significantly for signal levels below vertical line 720.

As a contrast, FIG. 7B shows results for non-uniform quantization at 6-bits as a scatter plot 700b, with data points 712 plotted using a signal value axis 702 for the 6-bit quantization versus a signal value axis 704 for the 16-bit quantization. Data points 712 are from quantization using inverse μ-law function 312 (Eq. (1)) with μ=255. As can be easily seen data points 712 does not fan out for signal levels below vertical line 720 anywhere near as much as does data points 710. This indicates that the acceptable dynamic range for non-uniform quantization expends significantly into lower signal values.

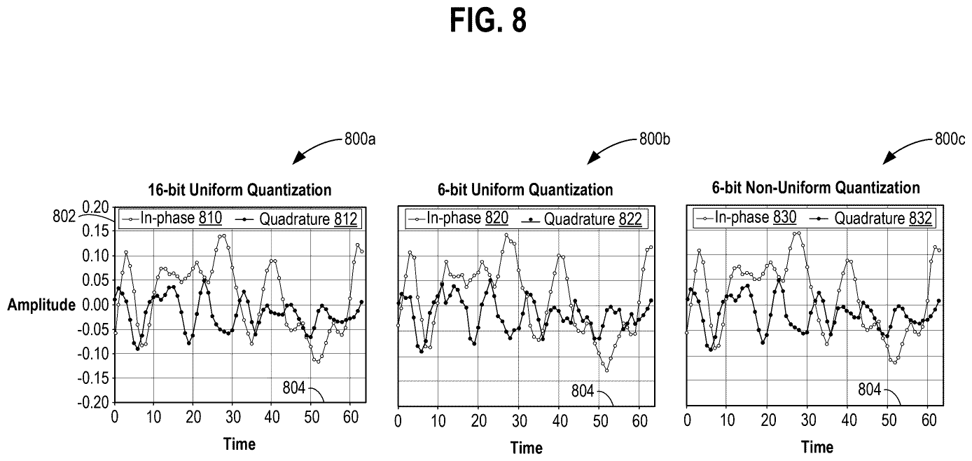

FIG. 8 illustrates exemplary comparisons of I/Q radar data for various quantization scenarios. A plot 800a shows in-phase signal amplitude 810 and quadrature-phase signal amplitude 812 plotted using an amplitude axis 802 versus a time axis 804 for 16-bit uniform quantization reference signals. A plot 800b shows in-phase signal amplitude 820 and quadrature-phase signal amplitude 822 plotted using amplitude axis 802 versus time axis 804 for 6-bit uniform quantization signals. A plot 800c shows in-phase signal amplitude 830 and quadrature-phase signal amplitude 832 plotted using amplitude axis 802 versus time axis 804 for 6-bit non-uniform quantization signals, using inverse μ-law function 312 (Eq. (1)) with μ=255 (e.g., non-uniform quantized I/Q radar data 130a). A visual comparison indicates that signal amplitude 830 more closely resembles signal amplitude 810 than does signal amplitude 820, and signal amplitude 832 more closely resembles signal amplitude 812 than does signal amplitude 822. This indicates that non-uniform quantization preserves signal fidelity better than uniform quantization, at least for a bit depth of 6, for this low-SNR example.

FIG. 9 illustrates further detail for generation of output data product 150. Non-uniform quantized radar signal 120a is provided to pulse compression filter 900, which generates non-uniform quantized I/Q radar data 130a. This version of non-uniform quantized I/Q radar data 130a may be sent to storage device 118 and/or processing 140. Processing 140 has beamformer 142 and an alias filter 904 to filter out aliasing. An image formation processing 906 generates output data product 150.

In some examples, output data product 150 comprises a two-dimensional (2D) image 910 that plots a weather radar variable 914 (e.g., reflectivity factor \hat{Z}) versus dimensions 916 of angle and range (polar coordinates). In such examples, pixels of 2D image 910 comprise values of weather radar variable 914. In some examples, output data product 150 comprises a three-dimensional (3D) volume representation 912 that plots a weather radar variable 914 versus dimensions 918 of azimuth, elevation, and range (spherical coordinates). In such examples, 3D volume representation 912 may comprise a point cloud, and voxels of 3D volume representation 912 comprise values of weather radar variable 914. In some examples, 2D image 910 or 3D volume representation 912 is plotted in Cartesian coordinates.

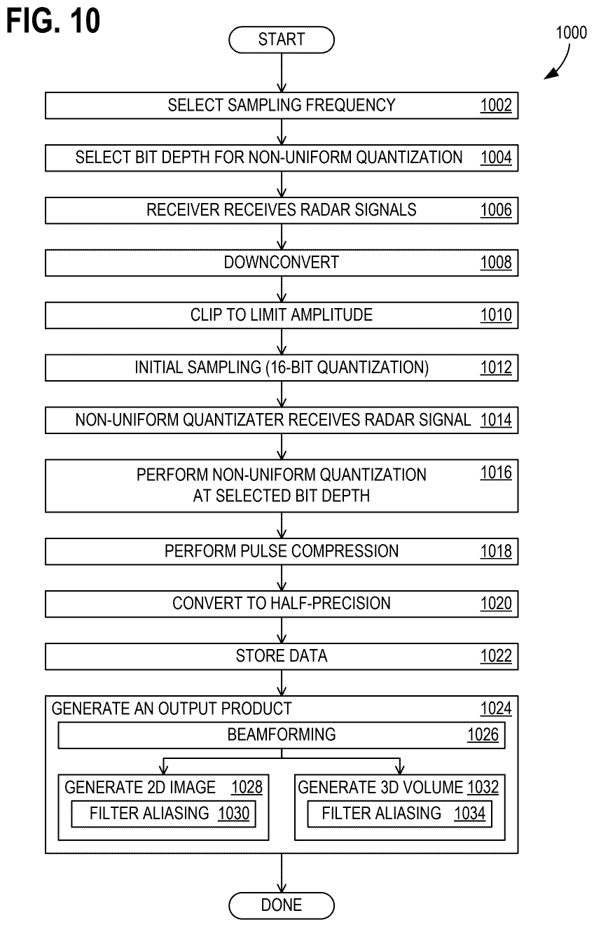

FIG. 10 illustrates a flowchart 1000 of exemplary operations associated with examples of architecture 100. In some examples, at least a portion of flowchart 1000 may be performed using one or more computing devices 1200 of FIG. 12. Flowchart 1000 commences with selecting sampling frequency 302, based on at least baseband frequency 114, in operation 1002. In some examples, if radar signal 110a is already quantized (e.g., at 16-bits), sampling frequency 302 is selected to be the same as the sampling frequency at which radar signal 110a was previously quantized. In some examples, sampling frequency 302 is between 15 MS/s and 25 MS/s, inclusive.

Bit depth 304 is selected in operation 1004. In some examples, bit depth 304 is selected based on at least weather radar variable 914, which may be of: target SNR, reflectivity factor, Doppler velocity, spectrum width, and a polarimetric variable, such as differential reflectivity, or specific differential phase, or correlation coefficient. That is, weather radar variable 914 may be any of the variables shown in shown in Eq. (8) to Eq. (13). In some examples, bit depth 304 is between 5 and 8, inclusive, such as 6 or 7. In some examples, sampling frequency 302 and bit depth 304 are each selected based at least partially on each other.

Operations 1006 to 1022 are described for radar signal 110a, non-uniform quantized radar signal 120a, and non-uniform quantized I/Q radar data 130a, although it should be understood that in arrangements that use multiple signals, such as PARs, operations 1006-1022 are also performed for each signal of plurality of radar signals 110, plurality of non-uniform quantized radar signals 120, and plurality of non-uniform quantized I/Q radar data 130.

Radar receiver 200 receives radar signal 110a at operational RF 112 in operation 1006. In some examples, operational RF 112 is between 2.5 GHz and 3.5 GHz, such as 2.7-3.1 GHz. In some examples, radar receiver 200 comprises a receiver of weather surveillance radar 102 and in some further examples, weather surveillance radar 102 comprises a phased array weather radar. Operation 1008 downconverts radar signal 110a from operational RF 112 to baseband frequency 114. In some examples, operation 1010 clips I/Q data based on an expected amplitude range, and operation 1012 quantizes radar signal 110a at bit depth 204 (e.g., 16).

In operation 1014, non-uniform quantizer 300 receives radar signals 110a at baseband frequency 114. Radar signal 110a may either be an analog signal or a quantized signal at bit depth 204. Operation 1016 quantizes radar signal 110a into non-uniform quantized radar signal 120a, according to sampling frequency 302 and bit depth 304. This may be either quantizing analog signal data or converting from quantization from bit depth 204 to bit depth 304. Quantization intervals 310 of non-uniform quantized radar signal 120a are not uniform, but instead may provide higher resolution for low amplitude signals 506 and lower resolution for high amplitude signals 508. In some examples, quantization intervals 310 follow inverse μ-law function 312, as shown in Eq. (1). In some examples, is within a range of 200 to 300, inclusive, such as a value of 255. In some examples, is within a range of 100 to 400.

Operation 1018 performs pulse compression on non-uniform quantized radar signal 120a to generate non-uniform quantized I/Q radar data 130a. In some examples, operations 1016 and 1018 are swapped. Operation 1020 stores non-uniform quantized I/Q radar data 130a in non-transitory computer readable media, such as storage device 118.

Operation 1022 generates output data product 150 for non-uniform quantized I/Q radar data 130a (e.g., for real-beam radars) or for plurality of non-uniform quantized I/Q radar data 130 (e.g., for PARs). Operation 1024 performs beamforming with set of non-uniform quantized I/Q radar data 130. Some examples with dish-based radars swap beamforming in operation 1024 with pulse compression in operation 1018 although pulse compression is also used on PARs. For dish-based radars, beamforming is not used, although other beam shaping techniques, such as tapering, may be used.

Operation 1026 generates 2D image 910 using plurality of non-uniform quantized I/Q radar data 130 (or non-uniform quantized I/Q radar data 130a). In some examples, operation 1026 includes operation 1028 that filters out aliasing. This is possible, even if sampling frequency 302 is below the Nyquist frequency, because the operational frequencies of weather surveillance radar 102 are known. In addition, or alternatively, operation 1030 generates 3D volume representation 912 using plurality of non-uniform quantized I/Q radar data 130 (or non-uniform quantized I/Q radar data 130a). In some examples, operation 1030 includes operation 1032 that filters out aliasing.

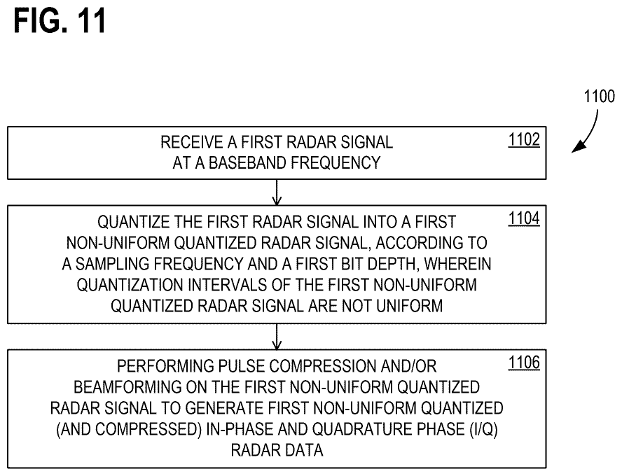

FIG. 11 illustrates a flowchart 1100 of exemplary operations associated with architecture 100. In some examples, at least a portion of flowchart 1100 may be performed using one or more computing devices 1200 of FIG. 12. Flowchart 1100 commences with operation 1102, which includes receiving a first radar signal at a baseband frequency. Operation 1104 includes quantizing the first radar signal into a first non-uniform quantized radar signal, according to a sampling frequency and a first bit depth, wherein quantization intervals of the first non-uniform quantized radar signal are not uniform. Operation 1106 includes performing pulse compression and/or beamforming on the first non-uniform quantized radar signal to generate first non-uniform quantized I/Q radar data.

FIG. 12 illustrates a block diagram of computing device 1200 that may be used as any component described herein that may require computational or storage capacity. Computing device 1200 has at least a processor 1202 and a memory 1204 that holds program code 1210, data area 1220, and other logic and storage 1230. Memory 1204 is any device allowing information, such as computer executable instructions and/or other data, to be stored and retrieved. For example, memory 1204 may include one or more random access memory (RAM) modules, flash memory modules, hard disks, solid-state disks, persistent memory devices, and/or optical disks. Program code 1210 comprises computer executable instructions and computer executable components including instructions used to perform operations described herein. Data area 1220 holds data used to perform operations described herein. Memory 1204 also includes other logic and storage 1230 that performs or facilitates other functions disclosed herein or otherwise required of computing device 1200. An input/output (I/O) component 1240 facilitates receiving input from users and other devices and generating displays for users and outputs for other devices. A network interface 1250 permits communication over external network 1260 with a remote node 1270, which may represent another implementation of computing device 1200. For example, a remote node 1270 may represent another of the above-noted nodes within architecture 100.

### Additional Examples

An example system comprises: a processor; and a computer-readable medium storing instructions that are operative upon execution by the processor to: receive a first radar signal at a baseband frequency; quantize the first radar signal into a first non-uniform quantized radar signal, according to a sampling frequency and a first bit depth, wherein quantization intervals of the first non-uniform quantized radar signal are not uniform; and perform pulse compression and/or beamforming on the first non-uniform quantized radar signal to generate first non-uniform quantized I/Q radar data.

An example method of wireless communication comprises: receiving a first radar signal at a baseband frequency; quantizing the first radar signal into a first non-uniform quantized radar signal, according to a sampling frequency and a first bit depth, wherein quantization intervals of the first non-uniform quantized radar signal are not uniform; and performing pulse compression and/or beamforming on the first non-uniform quantized radar signal to generate first non-uniform quantized I/Q radar data.

One or more example computer storage devices has computer-executable instructions stored thereon, which, upon execution by a computer, cause the computer to perform operations comprising: receiving a first radar signal at a baseband frequency; quantizing the first radar signal into a first non-uniform quantized radar signal, according to a sampling frequency and a first bit depth, wherein quantization intervals of the first non-uniform quantized radar signal are not uniform; and performing pulse compression and/or beamforming on the first non-uniform quantized radar signal to generate first non-uniform quantized I/Q radar data.

Alternatively, or in addition to the other examples described herein, examples include any combination of the following:
storing the first non-uniform quantized I/Q radar data in a non-transitory computer readable media;
generating a 2D image using the first non-uniform quantized I/Q radar data;
dimensions of the 2D image comprise angle and range;
pixels of the 2D image comprise values of a weather radar variable;
generating a 3D volume representation of the first non-uniform quantized I/Q radar data;
dimensions of the 3D volume representation comprise azimuth, elevation, and range;
voxels of the 3D volume representation comprise values of a weather radar variable;
selecting the first bit depth based on at least the weather radar variable;
the weather radar variable is selected from the list consisting of: a reflectivity factor Z, a Doppler velocity, a spectrum width, and a polarimetric variable;
the polarimetric variable comprises a differential reflectivity, or a specific differential phase, or a correlation coefficient;
selecting the sampling frequency based on at least the baseband frequency;
the sampling frequency and the bit depth are each selected based at least partially on the other;
receiving the first radar signal at the baseband frequency comprises receiving an analog signal at the baseband frequency;
receiving the first radar signal at the baseband frequency comprises receiving a quantized radar signal at the baseband frequency, quantized at a second bit depth above the first bit depth;
the second bit depth is 16;
the first bit depth is between 5 and 8, inclusive;
the sampling frequency is between 15 MS/s and 25 MS/s, inclusive;
clipping I/Q data based on at least an expected amplitude range;
quantization intervals of the first non-uniform quantized radar signal providing higher resolution for low amplitude signals and lower resolution for high amplitude signals;
quantization intervals of the first non-uniform quantized radar signal follow an inverse μ-law function;
μ is within a range of 200 to 300, inclusive;
μ is within a range of 100 to 400, inclusive;
the inverse μ-law function is defined by:

$$y ( x ) = {f}^{- 1} ( x ) = sgn ( x ) \frac{V [ {e}^{x \frac{ln ( 1 + μ )}{V}} - 1 ]}{μ}$$

where x is the first radar signal, V is an amplitude limit of the first radar signal such that |x|≤V, and

$$f ( x ) = V \frac{ln ( 1 + \frac{μ \vert x \vert}{V} )}{ln ( 1 + μ )} ;$$

receiving, by a radar receiver, the first radar signal at an operational RF;
the operational RF is between 2.5 GHz and 3.5 GHz;
the radar receiver comprises a receiver of a weather surveillance radar;
the weather surveillance radar comprises a phased array weather radar;
downconverting the first radar signal from the operational RF to the baseband frequency;
receiving a plurality of radar signals at the baseband frequency, including the first radar signal, wherein each radar signal of the plurality of radar signals corresponds to an element of a phased array;
quantizing the plurality radar signals into a plurality of non-uniform quantized radar signals, according to the sampling frequency and the first bit depth, wherein quantization intervals of the plurality of non-uniform quantized radar signals are not uniform;
performing pulse compression on the plurality of non-uniform quantized radar signals to generate a set of non-uniform quantized I/Q radar data;
storing the set of non-uniform quantized I/Q radar data in a non-transitory computer readable media; and
performing beamforming with the set of non-uniform quantized I/Q radar data.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media. The term “computer readable media” may be one or more integrated circuits.

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving a first radar signal at a baseband;
quantizing the first radar signal into a first non-uniform quantized radar signal, according to a sampling frequency and a selected bit depth, wherein quantization intervals of the first non-uniform quantized radar signal are not uniform; and
performing pulse compression and/or beamforming on the first non-uniform quantized radar signal to generate first non-uniform quantized in-phase and quadrature phase (I/Q) radar data.

2. The method of claim 1, further comprising:
generating a two-dimensional (2D) image or a three-dimensional (3D) volume representation using the first non-uniform quantized I/Q radar data; wherein pixels of the 2D image or voxels of the 3D volume representation comprise values of a weather radar variable; and
wherein the weather radar variables are selected from a list comprising:
a reflectivity factor, a Doppler velocity, a spectrum width, and polarimetric variables of differential reflectivity, specific differential phase, and correlation coefficient.

3. The method of claim 2, further comprising:
selecting a bit depth based on at least a minimized error for each weather radar variable.

4. The method of claim 1, further comprising:
selecting the sampling frequency and a compression filter length based on at least a required bandwidth.

5. The method of claim 1, wherein the quantization intervals of the first non-uniform quantized radar signal provide higher resolution for low amplitude signals and lower resolution for high amplitude signals.

6. The method of claim 1, wherein the quantization intervals of the first non-uniform quantized radar signal follow an inverse μ-law function, wherein μ is within a range of 100 to 400, inclusive.

7. The method of claim 1, further comprising:
receiving a plurality of radar signals at baseband, including the first radar signal, wherein each radar signal of the plurality of radar signals corresponds to an element of a phased array;
quantizing the plurality of radar signals into a plurality of non-uniform quantized radar signals, according to the sampling frequency and a selected bit depth, wherein quantization intervals of the plurality of non-uniform quantized radar signals are not uniform; and
performing pulse compression on the plurality of non-uniform quantized radar signals to generate a set of non-uniform quantized I/Q radar data.

8. A system comprising:
a processor; and
a computer-readable medium storing instructions that are operative upon execution by the processor to:
receive a first radar signal at a baseband;
quantize the first radar signal into a first non-uniform quantized radar signal, according to a sampling frequency and a selected bit depth, wherein quantization intervals of the first non-uniform quantized radar signal are not uniform; and
perform pulse compression and/or beamforming on the first non-uniform quantized radar signal to generate first non-uniform quantized in-phase and quadrature phase (I/Q) radar data.

9. The system of claim 8, wherein the instructions are further operative to:
generate a two-dimensional (2D) image or a three-dimensional (3D) volume representation using the first non-uniform quantized I/Q radar data; wherein pixels of the 2D image or voxels of the 3D volume representation comprise values of a weather radar variable; and
wherein the weather radar variables are selected from a list comprising:
a reflectivity factor, a Doppler velocity, a spectrum width, and polarimetric variables of differential reflectivity, specific differential phase, and correlation coefficient.

10. The system of claim 9, wherein the instructions are further operative to:
select a bit depth based on at least a minimized error for each weather radar variable.

11. The system of claim 8, wherein the instructions are further operative to:
select the sampling frequency and a compression filter length based on at least a required bandwidth.

12. The system of claim 8, wherein the quantization intervals of the first non-uniform quantized radar signal provide higher resolution for low amplitude signals and lower resolution for high amplitude signals.

13. The system of claim 8, wherein the quantization intervals of the first non-uniform quantized radar signal follow an inverse μ-law function, wherein μ is within a range of 100 to 400, inclusive.

14. The system of claim 8, wherein the instructions are further operative to:
receive a plurality of radar signals at baseband, including the first radar signal, wherein each radar signal of the plurality of radar signals corresponds to an element of a phased array;
quantize the plurality of radar signals into a plurality of non-uniform quantized radar signals, according to the sampling frequency and a selected bit depth, wherein quantization intervals of the plurality of non-uniform quantized radar signals are not uniform; and
perform pulse compression on the plurality of non-uniform quantized radar signals to generate a set of non-uniform quantized I/Q radar data.

15. An integrated circuit comprising computer-readable medium with computer-executable instructions stored thereon, which, upon execution by a computer, cause the computer to perform operations comprising:
receiving a first radar signal at a baseband;
quantizing the first radar signal into a first non-uniform quantized radar signal, according to a sampling frequency and a selected bit depth, wherein quantization intervals of the first non-uniform quantized radar signal are not uniform; and
performing pulse compression and/or beamforming on the first non-uniform quantized radar signal to generate first non-uniform quantized in-phase and quadrature phase (I/Q) radar data.

16. The integrated circuit of claim 15, wherein the operations further comprise:
generating a two-dimensional (2D) image or a three-dimensional (3D) volume representation using the first non-uniform quantized I/Q radar data; wherein pixels of the 2D image or voxels of the 3D volume representation comprise values of a weather radar variable; and
wherein the weather radar variables are selected from a list comprising:
a reflectivity factor, a Doppler velocity, a spectrum width, and polarimetric variables of differential reflectivity, specific differential phase, and correlation coefficient.

17. The integrated circuit of claim 16, wherein the operations further comprise:
selecting a bit depth based on at least a minimized error for each weather radar variable.

18. The integrated circuit of claim 15, wherein the operations further comprise:
selecting the sampling frequency and a compression filter length based on at least a required bandwidth.

19. The integrated circuit of claim 15, wherein the quantization intervals of the first non-uniform quantized radar signal provide higher resolution for low amplitude signals and lower resolution for high amplitude signals.

20. The integrated circuit of claim 15, wherein the quantization intervals of the first non-uniform quantized radar signal follow an inverse μ-law function, wherein μ is within a range of 100 to 400, inclusive.
